(19) United States
(12) Patent Application Publication
(10) Pub. No.: US 2026/0350361 A1
(43) Pub. Date: Nov. 5, 2026

(54) SYSTEMS AND METHODS FOR VISION-LANGUAGE MODELS OF AGENTIC OPERATIONS

(71) Applicant: Salesforce, Inc., San Francisco, CA (US)

(72) Inventors: Jefferson Grigsby, Palo Alto, CA (US); Michael S. Ryoo, New York, NY (US); Juan Carlos Niebles Duque, Mountain View, CA (US)

(21) Appl. No.: 19/192,116

(22) Filed: Apr. 28, 2025

(51) Int. Cl. G06N 3/0455; G06N 3/084

(52) U.S. Cl. CPC G06N 3/0455; G06N 3/084

(57) ABSTRACT

Embodiments described herein provide a reinforcement learning (RL)-based framework to fine-tune VLMs for agent tasks such that the finetuned VLM may produce outputs that align with agent tasks (toward achieving success in the designated task) by optimizing the VLM's decision-making behavior within an environment. Specifically, the training framework may adopt offline RL techniques-filtered supervised fine-tuning (FSFT)—which selectively filters demonstration datasets using a learned value model. Unlike standard offline RL methods, the training framework uses FSFT to surpass its demonstrations while remaining identical to SFT when data quality is high. Additionally, FSFT enables seamless data collection for further improvement, making it a low-risk, high-reward alternative to SFT in VLM agent training

### TECHNICAL FIELD

The embodiments relate generally to machine learning systems for automatic artificial intelligence agents, and more specifically to systems and methods for vision-language models of agentic operations.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative large language model (LLM) to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. For example, vision-language models (VLMs) may extend LLMs to multi-modal data (e.g., text, code, image, video, etc.) and provide AI agents with the visual reasoning necessary for new applications in areas such as computer automation. For instance, the VLM may generate control command to control a cursor to navigate a web page and identify where to fill in an information, such as a web address bar, and/or the like. However, existing VLMs often lack the ability to follow the strict output syntax requirements of a computing environment. Finetuning VLMs with visual data with syntax information often requires task-specific expert demonstrations, which can be both time-consuming and costly.

### BRIEF DESCRIPTION OF THE DRAWINGS

FIG. 1 shows an example operation of an LLM based AI agent, according to embodiments of the present disclosure.

FIG. 2A provides an example block diagram illustrating aspects of VLM-environment interaction as an RL setup, according to embodiments described herein.

FIG. 2B provides an example block diagram illustrating aspects of converting between interaction turns and tokens during VLM-environment interactions shown in FIG. 2A, according to embodiments described herein.

FIG. 3 provides an example block diagram illustrating aspects of a training stage of the VLM 210 shown in FIGS. 2A-2B, according to embodiments described herein.

FIG. 4 is a simplified diagram illustrating a computing device implementing the VLM agent described in FIGS. 1-3, according to some embodiments.

FIG. 5 is a simplified diagram illustrating a neural network structure, according to some embodiments.

FIG. 6 is a simplified block diagram of a networked system suitable for implementing the VLM agent framework described in FIGS. 1-5 and other embodiments described herein.

FIGS. 7A-7B are an example logic flow diagram illustrating a method of based on the framework shown in FIGS. 1-6, according to some embodiments described herein.

FIGS. 8-11 represent exemplary test results using embodiments described herein, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

LLMs are often pre-trained on diverse datasets encompassing various domains of knowledge, enabling them to generate contextually relevant text across a wide range of topics and/or tasks. For example, LLM pre-training produces a model that outputs the most likely continuation of its input text according to a distribution of training examples sourced from across the web. However, in other types of tasks, where the LLM acts as an agent in an interactive environment and makes a sequence of decisions to maximize its success rate, the LLM may not have been trained to optimize this objective, e.g., to book a light based on user preference or schedule. The best decision-making strategy (e.g., choose the right booking site for booking, or choose the right flight based on user schedule, etc.) may be an unlikely output.

However, pre-training a Vision-Language Model (VLM) presents significant challenges, as acquiring diverse and comprehensive visual data is inherently difficult. Additionally, training a VLM to perform a specific task with a well-defined objective is complex, as visual information is less structured than textual data, making it harder to align model outputs with precise functional requirements. In addition, training VLM may face challenges that would not otherwise occur with training LLMs: (1) agent action syntax and (2) long-context prompting. Agent tasks typically require structured outputs that the environment can interpret rather than freeform dialogue.

In addition, a more significant long-term challenge in training VLMs arises from the need to handle environment interactions that span multiple model outputs. Unlike single-turn tasks, these interactions require the model to maintain consistency and coherence over extended sequences, making it infeasible to provide complete in-context examples within standard prompt length limitations. This constraint complicates alignment through prompting alone, necessitating alternative training strategies such as memory-augmented architectures, reinforcement learning, or hierarchical planning mechanisms to ensure effective long-term reasoning and decision-making.

Embodiments described herein provide a reinforcement learning (RL)-based framework to fine-tune VLMs for agent tasks such that the finetuned VLM may produce outputs that align with agent tasks (toward achieving success in the designated task) by optimizing the VLM's decision-making behavior within an environment. Specifically, the training framework may adopt offline RL techniques-filtered supervised fine-tuning (FSFT)—which selectively filters demonstration datasets using a learned value model. Unlike standard offline RL methods, the training framework uses FSFT to surpass its demonstrations while remaining identical to SFT when data quality is high. Additionally, FSFT enables seamless data collection for further improvement, making it a low-risk, high-reward alternative to SFT in VLM agent training.

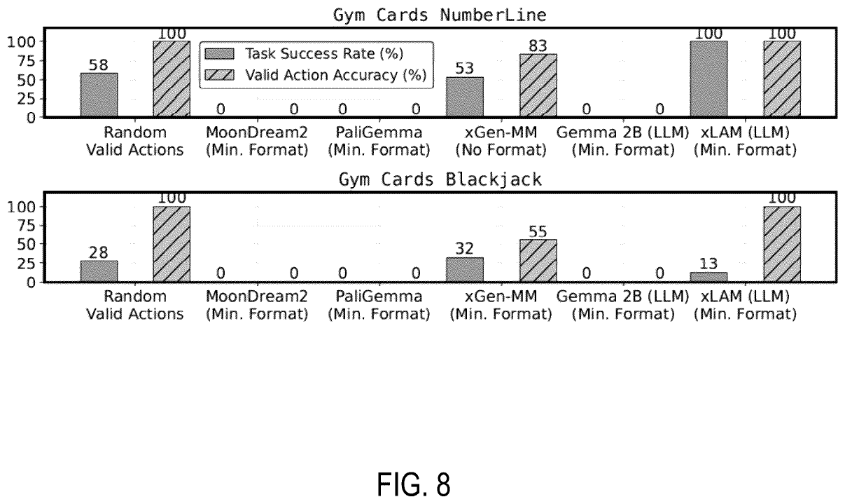

In this way, the RL enhances the VLM agent by enabling fine-tuning for agent tasks while leveraging unsuccessful decisions from both the model itself and more capable (larger) models. Such finetuning may be applied for online RL, offline RL, on and off-policy RL, and/or the like, maintaining the stability and simplicity of the widely used SFT workflow while introducing the ability for agents to self-improve. As further illustrated in FIGS. 8-11, with improved performance of the VLM agent in complex decision-making tasks, AI agent technology is improved.

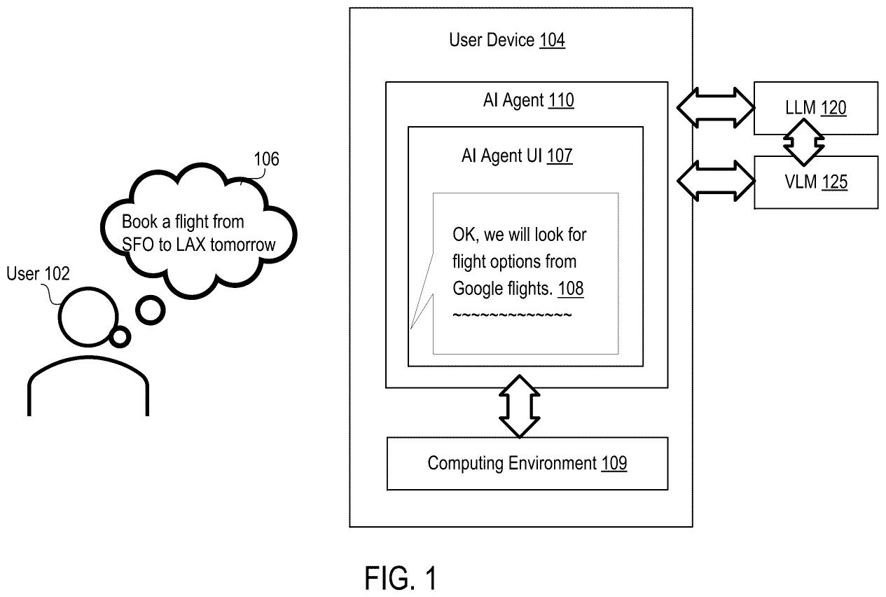

FIG. 1 shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “book a flight from SFO to LAX tomorrow evening” 106.

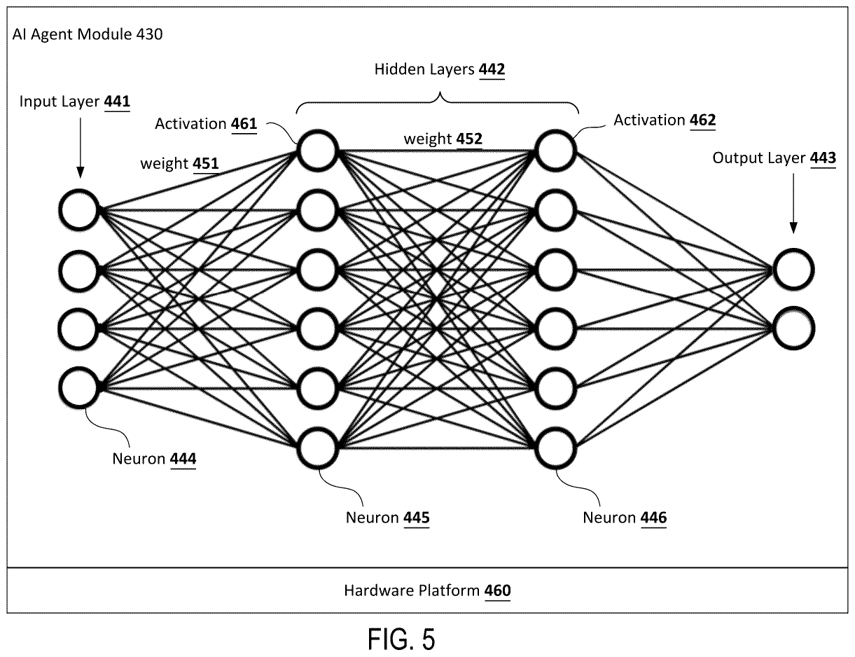

In one embodiment, the AI agent 110 may processes the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” The LLM 120 may in turn generate a textual response 108 based on an input combining the task request 106 and any system prompt. Additional details on the LLM 120 generating output tokens to form the response 108 may be described in FIG. 5.

The textual response 108 may include instructions, explanations, or direct actions to address the task request 106. Such textual response 108 is displayed via the AI agent interface 107 for transparency. In addition to the textual response 108 that describes how to fulfill the task request, the LLM 120 may generate computer-executable commands (e.g., system-level commands, Python scripts, etc.) that can directly trigger actions and/or interactions with the computing environment 109 on the user device 104.

In some implementations, the AI agent may further adopt a multimodal vision-language module 125, which may be a separate model, or be integrated with LLM 120. The VLM 125 may receive screenshots from the computing environment 109, e.g., a browser application UI so as to extract textual and visual information from each web page. The VLM 125 may then identify key elements such as input fields, labels, and buttons and generate an output indicating where to fill in the form with what information. For example, the VLM 125 may process visual information (such as screenshots of the UI) and text information (such as user provided user name, date of birth, etc., or retrieved profile information from a browser application, etc.) to generate an output code script that fill in the text information into the right fields on a browser UI.

For example, when the user 102 requests to book a flight, the LLM 120 and the VLM 125 may output a code script to execute on a browser application on the user device 104 to visit a search website, search for flights from the origin to the destination, navigate the webpages to book the flight, and/or interface with APIs of other applications to automate tasks such as adding the flight information to a calendar application, and/or the like.

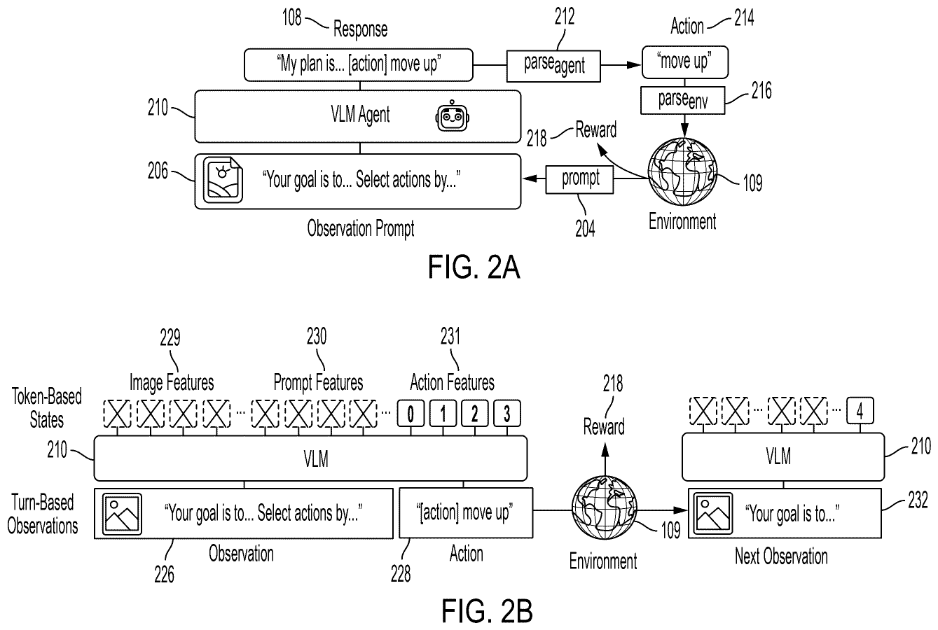

FIG. 2A provides an example block diagram illustrating aspects of VLM-environment interaction as an RL setup, according to embodiments described herein. As shown in FIG. 2A, agent interaction between the VLM agent 210 (e.g., similar to AI agent 110 in FIG. 1) and computing environment 119 may be formulated via a RL network, where the VLM agent 210 functions as an RL policy mapping text and image observations 206 to a response 108 of text actions.

In one embodiment, agent interaction may often comprise a plurality of turns, e.g., a turn refers to a single step of interaction between the VLM agent 210 and the environment, 109 where the agent 210 receives an observation 206 and generates a response 108. For example, a single turn may comprise an observation of the environment 109, e.g., a current webpage, which contains a search bar and a button labeled “Search.” On each turn t, the environment 109 provides an observation of text (o^{text}) and image (o^{img}) data. Here, text may be represented by tokens from the VLM's output vocabulary, [symbol] , and the image may comprise a screenshot of the environment 109. A prompt 204 may reformat information from the environment 109 into a full input prompt 206, including a description of the agent's objective. Thus, in the above example, an observation prompt 206 may be formulated based on the text observation “You are on the Google homepage. There is a search bar” and an image observation of a screenshot of the webpage.

The VLM agent 210 may receive the observation prompt 206, and then the agent's policy π may samples an action at 108 from an action space [symbol] . Specifically, the action at 108 may be generated as a sequence of text tokens representing the agent's action. The open-ended text response 108 may be parsed first by an agent parser 212 to produce an action 214, e.g., in text, code, and/or other format. The parse_{agent} 212 enables arbitrary output formats including chain-of-thought-style reasoning. For example, reasoning (or “thought”) outputs by setting parse_{agent} to return only the text after the string “[action]”. This choice is arbitrary and could be replaced by a JSON output, for example. The VLM agent 210 thus need to output text actions 108 that are valid inputs to parseₑₙᵥ 216 and parse_{agent} 212. When the agent fails to do so, it will be given an error message and prompted to try again. VLMs that cannot break out of this loop create a sparse reward problem by failing to reach useful reward signals for training.

The parsed action 214 may then be parsed by the environment parser 216 to generate an actual executable action on the environment 109. For example, depending on the environment 109, the “true” action space [symbol] ′ may be text, code, or a set of discrete choices. We refer to this mapping from text actions 214 to true actions as parseₑₙᵥ 216: [symbol] → [symbol] ′. Because VLMs are sequence-to-sequence models, there are two ways to define the action space [symbol] . One option is to view each individual output token as a separate action ( [symbol] = [symbol] ). This “token-based view” most closely aligns with how sequence models are trained. During evaluation and data collection, it is simpler to take a “turn-based view” where each timestep is a full turn of dialogue and actions are complete replies with some maximum length r( [symbol] = [symbol] ^{r}).

In one embodiment, upon execution of the action 216 on the environment 109 (e.g., a browser application, a gaming application, etc.), the environment 109 may evolves to a new state and issue a reward 218 according to a transition process of the environment 109. For example, a browser environment 109 may update upon the action of “typing” search term into the search bar and press enter, and display search results. Thus, new text observation of “Search results are displayed, showing recent AI research article” and new image observation of a screenshot of the search results page may be obtained by the VLM agent 210 to generate a next step observation prompt 206. This cycle constitutes a single turn in which the agent 210 observes, acts, and receives feedback from the environment 109. Therefore, the RL network may use data (such as agent data trajectories) to discover a policy (of VLM agent 210) that maximizes the agent's return- or cumulative reward from the current state onwards, e.g.,

$${V}^{π} ( {s}_{t} ) = {𝔼}_{π} [ {\sum }_{i = t}^{∞} {γ}^{i - t} {r}_{i} ] ,$$

where γ∈[0,1) is a discount factor balancing short-term and long-term rewards. Additional details of the state transition of the RL network is further described in relation to FIG. 2B.

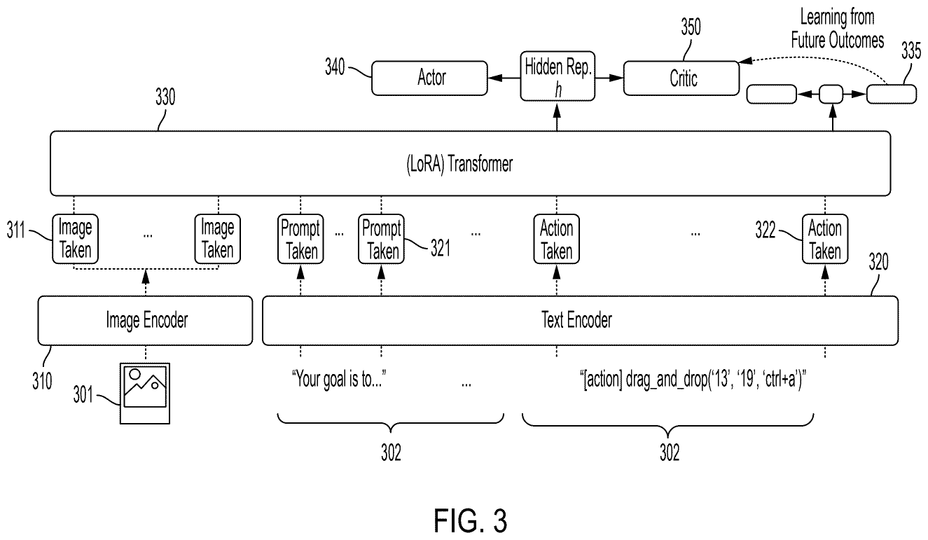

In one embodiment, the RL framework may be implemented as an off-policy RL, which may learn from any experience (action and reward) in the environment 109-regardless whether the actions for the current policy generates such experience. For example, a Q function may be computed to estimate the return that follows a particular action a: Q^{π}(sₜ, aₜ)=R(sₜ, aₜ)+V^{π}(sₜ₊₁) where R is the reward function. Therefore, Q may be maximized during training so as to improve the policy of the VLM agent 210 to select actions that maximizes Q. An actor-critic training framework to train a critic model to approximate Q and a second actor model to maximize the critic model's prediction may be further described in FIG. 3.

It is noted that the agent is responsible for producing text actions that parseₑₙᵥ can interpret; parsing open-ended text for concrete syntax is common in foundation model evaluations.

FIG. 2B provides an example block diagram illustrating aspects of converting between interaction turns and tokens during VLM-environment interactions shown in FIG. 2A, according to embodiments described herein. The framework may use turn-based transitions including the observations 226 (both text and image), the corresponding action aₜ 228, the corresponding reward 218, e.g.,

$$( ( {o}_{t}^{text} , {o}_{t}^{img} ) , {a}_{t} , {r}_{t + 1} , {d}_{t + 1} , ( {o}_{t + 1}^{text} , {o}_{t + 1}^{img} ) ) ,$$

where dₜ₊₁ is one if we've reached the final turn of the interaction and zero otherwise

The VLM 210 may comprise LLM layers, with VLM_{θ} represent the VLM architecture with all its parameters θ excluding the token output layer(s) at the end of the LLM. L_{φ} refers to the feed-forward language head that maps VLM_{θ}'s outputs to a distribution over the tokens in the VLM vocabulary V. While it is simpler to view agent-environment interaction from a turn-based perspective, the training process may convert data to a token-based action space. The end result will be a RL network where states are the output of the VLM, and the policy decides between | [symbol] | discrete actions.

For example, turn-based transition data may be converted from turns to tokens. During inference, the VLM 210 may tokenize the observations

$$226 ( {o}_{t}^{text} , {o}_{t}^{img} )$$

into a multimodal sequence and auto-regressively processes that sequence until a stop condition was met. Let ã be the tokenized action string 228 with length l. The true input sequence to the VLM is ã 228 concatenated to the end of a tokenized o^{img}, o^{text} 226. VLM_{θ} of VLM 210 outputs a sequence of d-dimensional vector representations including the image feature representation 229, prompt feature representation 230, and the last 1+1 indices of action feature representation 231 corresponding to the action decisions 231 to be optimized. Specifically, the process of VLM 210 retrieving the representations used to generate action tokens may take a form similar to

VLM_{θ}(o^{img},o^{text},a)=h∈ [symbol] ^{(l+1)×d.}

Querying the VLM 210 without the action text

$$( {VLM}_{θ} ( {o}^{img} , {o}_{t}^{text} ) )$$

returns the d-dimensional representation (of length one) that is used to begin the action reply. The operation

$${VLM}_{θ} ( {o}^{{img}_{t}} , {o}_{t}^{text} , {a}_{t} ) = {h}_{t}$$

may correspond to the evolution of a sequence of RL states. For example, the policy begins with

$${h}_{t}^{0} ,$$

selects a token action

$${\tilde{a}}_{t}^{0} ,$$

sees the state evolution to hₜ¹, and receives no reward. At the end of the turn, the policy selects a token that terminates generation and returns control to the environment. From the policy's perspective the next observation 232 is the first action query of the next turn, or

$${VLM}_{θ} ( {o}_{t + 1}^{img} , {o}_{t + 1}^{text} ) ,$$

with a reward and termination signal from the environment rₜ₊₁ and dₜ₊₁. Following this logic, a turn-based transition

$$( ( {o}_{t}^{img} , {o}_{t}^{text} ) , {a}_{t} , {r}_{t + 1} , {d}_{t + 1} , ( ( {o}_{t + 1}^{img} , {o}_{t + 1}^{text} ) )$$

is thus converted to token-based RL transitions by computing:

$$h = {VLM}_{θ} ( {o}_{t}^{img} , {o}_{t}^{text} , {a}_{t} ) \qquad ( 1 )$$

$${h}^{′} = \overline{△ \vert} {VLM}_{θ} ( {o}_{t + 1}^{img} , {o}_{t + 1}^{text} ) \qquad ( 2 )$$

Where [symbol] is a stop-gradient that puts the VLM in inference mode. The expanded batch of batch of RL transitions is:

$$( {h}^{0} , {\tilde{a}}_{t}^{0} , {r}^{1} = 0 , {d}^{1} = 0 , {h}^{1} ) , ( {h}^{1} , {\tilde{a}}_{t}^{1} , {r}^{2} = 0 , {d}^{2} = 0 , {h}^{2} ) , , ( {h}^{l} , {\tilde{a}}_{t}^{l} , {r}^{l + 1} = {r}_{t + 1} , {d}^{l + 1} = {d}_{t + 1} , {h}^{l + 1} = {h}^{′} ) .$$

After the conversion, the RL framework may proceed to generate the action (e.g., 108 in FIG. 2A) and issue a reward 218, and gradients may be computed and used to update the base VLM 210 iteratively.

FIG. 3 provides an example block diagram illustrating aspects of a training stage of the VLM 210 shown in FIGS. 2A-2B, according to embodiments described herein. As shown in FIG. 3, the VLM agent (e.g., 210 in FIGS. 2A-2B) may comprise an image encoder 310, a text encoder 320, a Transformer network 330, and one or more actor modules 340 and/or critic modules 350. For example, the Transformer network 330 may comprise a decoder-only Transformer model, and the one or more actor or critic modules 340 or 350 may comprise a feedforward layer head to map hidden states of the Transformer to a token distribution over the token vocabulary of the VLM.

At each training step, a batch of turn-based transitions may be sampled from training dataset D. Each turn-based transition comprises

$$( ( {o}_{t}^{img} , {o}_{t}^{text} ) , {a}_{t} , {r}_{t + 1} , {d}_{t + 1} , ( ( {o}_{t + 1}^{img} , {o}_{t + 1}^{text} ) )$$

The training data of turn-based transitions may be converted to a sequential RL problem in a forward pass of the VLM agent. For example, in one forward pass, the image observation

$${o}_{t}^{img} 301$$

may be encoded by the image encoder 310 into image representation tokens 311; the text observation

$${o}_{t}^{text} 302$$

concatenated with the action description at 302 (e.g., separated by a token [action]) may be encoded by the text encoder 320 into text representation tokens 321 and action representation tokens 322, respectively. The encoded tokens 311, 321 and 322 may then be passed to the Transformer network 330 to output the hidden states h at turn i, as similar to Eq. (1).

In one embodiment, an actor head module 340 (similar to the L_{φ} head described in relation to FIG. 2B above) may generate, based on the hidden states h, token distribution π(a|h) of the next step action. Thus, in one embodiment, supervised finetuning (SFT) may be adopted to train the VLM 210. In multi-turn SFT, the next-token prediction error may be computed causally along the entire sequence to mask the loss so that the likelihood of the agent's replies is maximized—in other words, the SFT loss for turn i may be computed based on an entropy of the output distribution over the tokens in the VLM vocabulary V conditioned on the RL state at turn i:

$${ℒ}_{SFT} ( i ) = - \frac{1}{l} {\sum }_{j = 0}^{l} log {L}_{ϕ} ( {\tilde{a}}_{i}^{j} \vert {h}_{i}^{j} ) . \qquad ( 3 )$$

The SFT loss may then be used to backpropagate one or more of the actor module 340, Transformer 330, the image encoder 310 and/or the text encoder 320.

In one embodiment, the SFT loss alone, however, may lead the finetuning to imitate every decision in the dataset and, therefore, cannot improve beyond the performance of the training dataset. In that case, the training dataset may be filtered with a function f(h, a)∈{0,1} to avoid imitating sub-optimal decisions:

$${ℒ}_{SFT} ( i ) = - \frac{1}{l} {\sum }_{j = 0}^{l} f ( {h}_{i}^{j} , {\tilde{a}}_{i}^{j} ) log {L}_{ϕ} ( {\tilde{a}}_{i}^{j} \vert {h}_{i}^{j} ) \qquad ( 4 )$$

In this case, the filter creates a second SFT mask for action tokens that should not be imitated. The filter may be a heuristic filter by masking low-return trajectories. Or the RL may outperform heuristics by learning a filter from data. For instance, a second output head, a critic module 350, Qu, may be used, which takes the hidden states h as input and produces | [symbol] | outputs-much like the language head L_{φ}. Let Q_{ψ}(h)[k] be the output corresponding to token k. Assuming Q_{ψ}outputs correct Q-values, the filter can be designed as:

$$f ( {h}_{i}^{j} , {\tilde{a}}_{i}^{j} ) = {Q}_{ψ} ( {h}_{i}^{j} ) [ {\tilde{a}}_{i}^{j} ] > {{Q}_{ψ} ( {h}_{i}^{j} )}^{T} {L}_{ϕ} ( {h}_{i}^{j} ) + β \qquad ( 5 )$$

In RL terminology, the filter approves actions that have an advantage of at least B:f(s, a)=Q^{π}(s,a)−V^{π}(s)>β. This filtered loss may be referred to as Advantage Filtered SFT (AFSFT). Thus, [symbol] _{FSFT}(i) may be used as an actor loss at turn i.

In one embodiment, the critic head module Q_{ψ} 350 may be trained with a one-step temporal difference (TD) loss. For example, an estimate of future return Q(s, a) 335 based on the current state s and action a may be created by using one ground-truth reward and approximating the rest of the timesteps with

$${Q}^{π} : {y}^{i} = {r}^{i + 1} + γ ( 1 - {d}^{i + 1} ) \text{?} ( {{Q}_{ψ} ( {h}^{i + 1} )}^{T} {L}_{ϕ} ( {h}^{i + 1} ) ) .$$

For stability, y is computed by a moving average of the critic parameters ψ, called a target network. Therefore, the current predictions may be updated based on the future return estimate. The TD loss is thus computed based on a difference between the Q_{ψ}output predictions and the estimated future return y:

$${ℒ}_{TD} ( i ) = - \frac{1}{l} {\sum }_{j = 0}^{l} {( {Q}_{ψ} ( {h}_{i}^{j} ) [ {\tilde{a}}_{i}^{j} ] - {y}_{i}^{j} )}^{2} \qquad ( 6 )$$

Therefore, a gradient to update the VLM agent may thus be computed using the joint loss:

$${ℒ}_{VLMQ} = {𝔼}_{i \sim D} [ {ℒ}_{FSFT} ( i ) + {λℒ}_{TD} ( i ) ] \qquad ( 7 )$$

Here, the use of stop-gradients in TD targets y and the filter f mean that the actor (language head) L_{φ} only optimizes LFSFT while the critic Q_{ψ} only optimizes LTD. However, the VLM trains on both objectives simultaneously and balances their values with a hyperparameter λ. In various embodiments, the VLM may be trained based on the SFT loss, FSFT loss, TD loss, either jointly, sequentially, or separately. In various embodiments, during one backpropagation based on any of the above described losses, one or more of the image encoder 310, text encoder 320, Transformer 330, actor 340 or critic 350 may be updated while other modules remain frozen.

In one embodiment, during training, GPU memory management techniques may be applied during optimization, including training in mixed precision with an 8-bit optimizer.

In one embodiment, the Transformer network 330 may be a Low-Rank Adaptation (LoRA) version to train the VLM with a small number of trainable parameters to improve training efficiency. For example, [symbol] _{FSFT} may retain the general behavior of the VLM 210 by imitating reward-free SFT tokens from a standard instruction-tuning dataset alongside RL training, but this would be expensive in practice. LoRA may allow discarding the weight adapters and recover the base model at any time during deployment.

In one embodiment, the training framework shown in FIG. 3 optimizes a policy loss that is a safe improvement over SFT in most cases and lets us recover SFT if necessary. When the learned filter f is noisy or near its initialization, Eq. (4) effectively becomes SFT on random subsets of the dataset. When Q-value estimation is successful, Eq. (4) creates a policy that outperforms its training data by declining to imitate action token outputs thought to be sub-optimal. There are some concerns when training on expert datasets where the dataset is of uniformly high quality, as the margin of advantages used to compute Eq. (4) would be close to zero. If the training dataset contains optimal decisions, the loss may be recovered to standard SFT with β=−∞and λ=0. Like SFT, but unlike many foundation model RL actor-critics, [symbol] _{VLMQ} requires a single base VLM. The only architectural addition is the critic output head Q_{ψ}.

### Computer and Network Environment

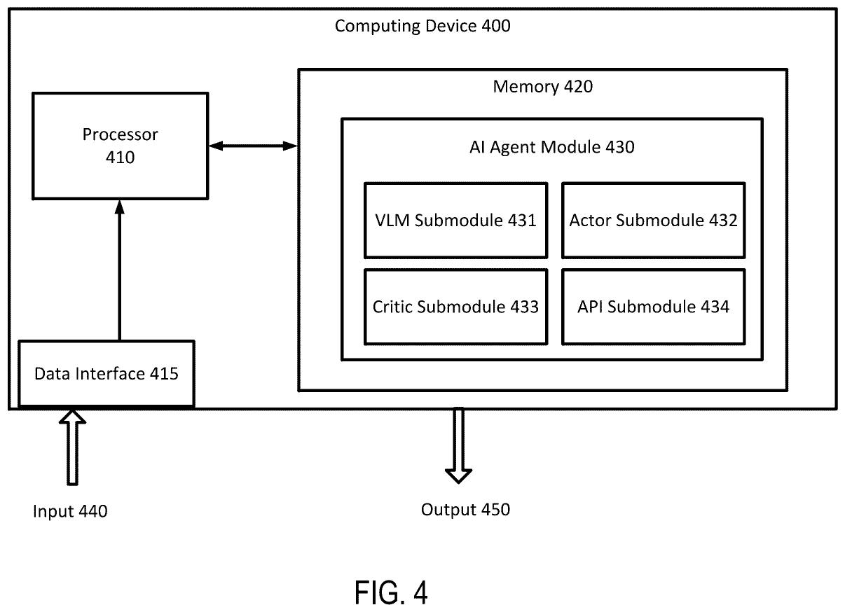

FIG. 4 is a simplified diagram illustrating a computing device implementing the VLM agent described in FIGS. 1-3, according to one embodiment described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 4B.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for VLM module 430 that may be used to implement and/or emulate the systems and models, and/or to implement any of the methods described further herein. VLM module 430 may receive input 440 such as an input training data (e.g., VLM agent data comprising turns of transitions) via the data interface 415 and generate an output 450 which may be a predicted next step action.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a user task request, from a user interface.

In some embodiments, the VLM module 430 is configured to generate and execution a sequence of actions to accomplish a user task request. The VLM module 430 may further include VLM submodule 431 (e.g., similar to 210 in FIGS. 2A-2B, which may further comprise an image encoder 310, a text encoder 320 and a Transformer model 330), an actor submodule 432 (e.g., similar to 340 in FIG. 3), a critic module 433 (e.g. similar to 350 in FIG. 3), and an API submodule 434. The API submodule 434 may be configured to interact with an environment on computing device 400, such as to obtain observations and/or to execute an action.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating the neural network structure implementing the VLM module 430 described in FIG. 4A, according to some embodiments. In some embodiments, the VLM module 430 and/or one or more of its submodules 431-434 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as a user task request. The number of nodes (neurons) in the input layer 441 may be determined by the dimensionality of the input data (e.g., the length of a vector of the user task request). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4, the VLM module 430 receives an input 440 of the observations and transforms the input into an output 450 of an action. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the VLM module 430 and/or one or more of its submodules 431-434 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a Transformer model, and/or the like.

In one embodiment, the VLM module 430 and its submodules 431-434 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the VLM module 430 and its submodules 431-434 may be implemented by hardware, software and/or a combination thereof. For example, the VLM module 430 and its submodules 431-434 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the VLM module 430 and its submodules 431-434 and/or any other neural network models onto hardware platform 460, the neural network based modules 430 and its submodules 431-434 may be optimized for deployment by converting it to a suitable format, such as ONNX or TensorRT, to improve performance and compatibility. Next, depending on the size and workload requirements for modules 430 and its submodules 431-434, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the VLM module 430 and its submodules 431-434 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the VLM module 430 and its submodules 431-434 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the VLM module 430 and its submodules 431-434 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the VLM module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based VLM module 430 and one or more of its submodules 431-434 may be trained by iteratively updating the underlying parameters (e.g., weights 451, 452, etc., bias parameters and/or coefficients in the activation functions 461, 462 associated with neurons) of the neural network based on the loss described in Eq. (4), Eq. (6). For example, during forward propagation, the training data such as VLM trajectory data are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding next step action) from the training data, to compute a loss function that measures the discrepancy between the predicted output and the expected output. For example, the loss function may be cross entropy, MMSE, or according to Eq. (4), (6), and/or the like. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based VLM module 430 and one or more of its submodules 431-434 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like, such as in Eq. (7). These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

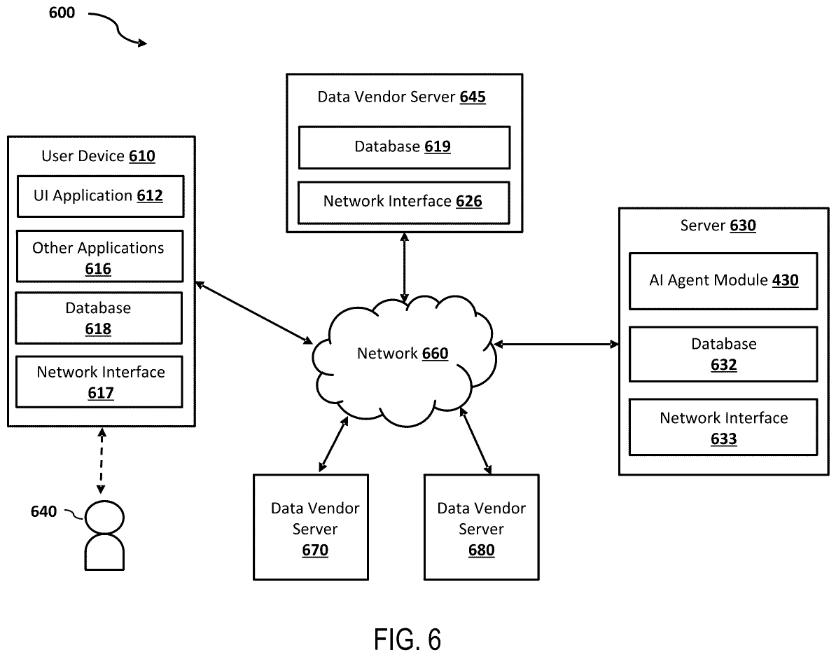

In some embodiments, VLM module 430 and its submodules 431-434 may be housed at a centralized server (e.g., computing device 400) or one or more distributed servers. For example, one or more of VLM module 430 and its submodules 431-434 may be housed at external server(s). The different modules may be communicatively coupled by building one or more connections through application programming interfaces (APIs) for each respective module. Additional network environment for the distributed servers hosting different modules and/or submodules may be discussed in FIG. 6.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as performing a task on a new and unseen website.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in automatic AI agents.

FIG. 6 is a simplified block diagram of a networked system 600 suitable for implementing the VLM agent framework described in FIGS. 1-5 and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating an action plan from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the VLM module 430 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which VLM module 430 may generate a response via the process described in FIGS. 1-5. The VLM module 430 may thus cause a display of action plan at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view an action plan, and/or an interactive workflow of the AI agent executing the action plan on a computing environment.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including VLM trajectories to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the VLM module 430 and its submodules described in FIG. 4A. In some implementations, VLM module 430 may receive data from database 619 at the data vendor server 645 via the network 660 to generate an action plan. The generated action plan may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the VLM module 430. In one implementation, the database 632 may store previously generated action plans and/or VLM trajectories, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flows

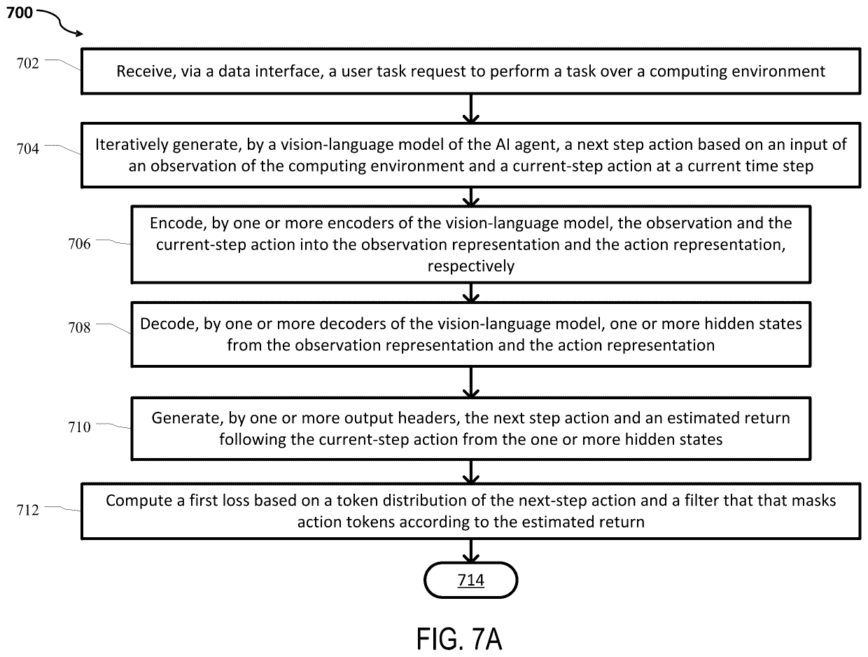

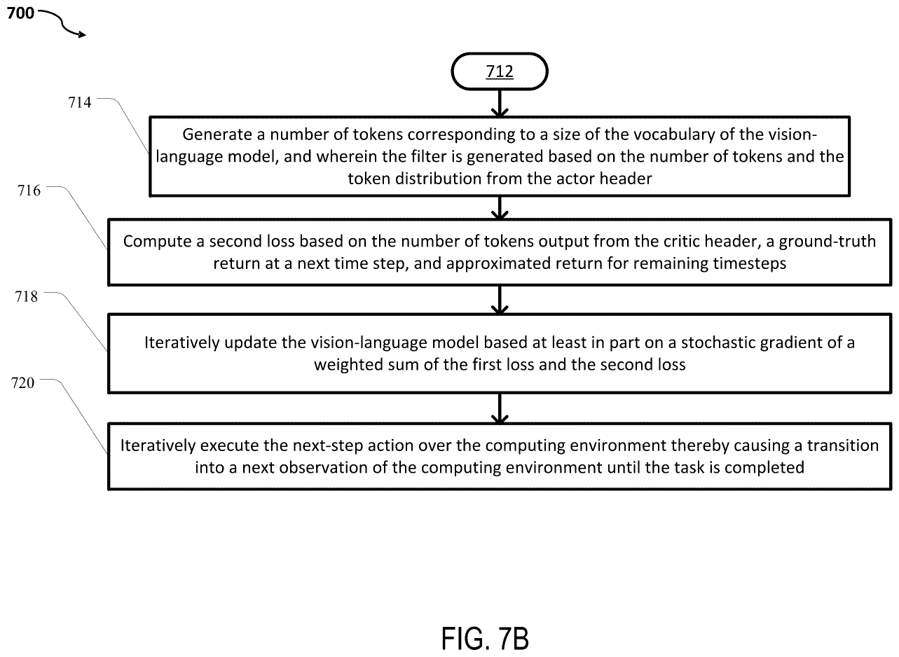

FIGS. 7A-7B are an example logic flow diagram illustrating a method of based on the framework shown in FIGS. 1-6, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the VLM module 430 (e.g., FIGS. 4 and 6) that implement an automatic AI agent over a computing environment via RL.

In some embodiments, method 700 is performed by a system such as computing device 400, user device 610, server 630, or another device or combination of devices. Inputs (e.g., such as a user request) may be received via a data interface such as data interface 415, network interface 617, network interface 633, or via a data interface that is integrated with a device. For example UI Application 612 may receive user inputs via a text input interface (e.g., keyboard), audio input (e.g., microphone), video interface (e.g., camera), or other interface for receiving user inputs (e.g., a mouse or touch display).

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, the AI agent may receive, via a data interface (e.g., 415 in FIG. 4, 633 in FIG. 6), a user task request (e.g., 106 in FIG. 1) to perform a task over a computing environment (e.g., 109 in FIGS. 1-3). For example, the user task request may require multiple turns of interaction, and the vision-language model may generate a sequence of action tokens for each turn. For example, the user task request may be decomposed into multiple turns of subtasks, and the vision-language model may generate a sequence of actions over multiple turns at each turn of the multiple turns. For another example, at training, the user task request may correspond to a training trajectory comprising multiple turns of transitions, and each turn of transition comprise the observation of the computing environment at the current turn, the current-turn action, a reward at the next turn, an indicator indicating whether the next turn reaches a final turn of task request execution, and an observation at the next turn.

At step 704, the AI agent may iteratively generate, by a vision-language model (e.g., 210 in FIGS. 2A-2B) of the AI agent, a next turn action (e.g., 214) based on an input of an observation (e.g., 206 in FIG. 2A), 226, 228 in FIG. 2B) of the computing environment. For example, the observation comprises an image of a screenshot of the computing environment at the current turn and a text description of a subtask request at the current turn decomposed from the task request.

The step 704 may be implemented through turns 706-710. Specifically, at turn 706, one or more encoders of the vision-language model may encode the observation and the current-turn action into the observation representation and the action representation, respectively. For example, the one or more encoders comprise an image encoder (e.g., 310 in FIG. 3) to encode the image of the screenshot into an image representation, and a text encoder (e.g., 320 in FIG. 3) to encoder the text description into a text representation.

At step 708, one or more decoders of the vision-language model may generate one or more hidden states from the observation representation and the action representation. For example, the one or more decoders of the vision-language model comprises a low-rank adapted version of a decoder-only Transformer network.

At step 710, one or more output headers (e.g., actor 340 and critic 350 in FIG. 3) may generate the next turn action and an estimated return following the current-turn action from the one or more hidden states. For example, the one or more output headers comprises an actor header (e.g., 340 in FIG. 3) that generates the token distribution of the next-turn action over a vocabulary of the vision-language model.

At step 712, the AI agent may compute a first loss based on a token distribution of the next-turn action and a filter that that masks action tokens according to the estimated return.

At step 714, the AI agent may generate a number of tokens corresponding to a size of the vocabulary of the vision-language model, and wherein the filter is generated based on the number of tokens and the token distribution from the critic header.

At step 716, the AI agent may compute a second loss (e.g., TD loss in Eq. (6)) based on the number of tokens output from the critic header, a ground-truth reward at a next turn, and approximated return for remaining turns.

At step 718, the AI agent may iteratively update the vision-language model based at least in part on a stochastic gradient of a weighted sum of the first loss and the second loss, e.g., Eq. (7).

At step 720, the AI agent may iteratively execute the next-turn action over the computing environment thereby causing a transition into a next observation of the computing environment until the task is completed.

In some embodiments, method 700 is applicable in a variety of applications. For example, the task request received by a neural network model (e.g., VLM 210) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 700, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 700 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface, may send system-level commands to the router to block the traffic in view of the identified anomaly, etc. In this way, IT anomalies may be detected and alerted using the neural network based artificial agent in an efficient manner so as to improve network support technology.

### Example Data Experiments

FIGS. 8-11 represent exemplary test results using embodiments described herein. In the data experiments, action space A′ consists of a small set of discrete choices, but the domain is made more representative of broader prompting challenges by setting parseₑₙᵥ to match a text action with only light corrections. The parse_{agent} syntax of “[action]” is selected because it allows the base model to pass the check by simply including the action string at the beginning of the reply.

FIG. 8 compares the performance of the three base VLMs listed in Table 1 when using only prompting, without additional fine-tuning. Results indicate that smaller open-weight VLMs struggle to adhere to the expected action syntax.

TABLE 1
VLM Baselines

| | MoonDream2 | PaliGemma | xGen-MM |
|---|---|---|---|
| Parameters | 1.9 B | 2.9 B | 4.6 B |
| Feature Dim. | 2048 | 2048 | 3072 |
| Vocabulary | 51.200 | 257,216 | 32,015 |

Action syntax is closely related to tool-use, where larger models tend to be more accurate, and this capability is more reliable in larger LLMs. This is further demonstrated by incorporating privileged environment data to add a text summary of the image to the observation prompt, allowing LLMs to function in a nearly equivalent setup by ignoring the visual input. xLAM, an LLM designed for tool-use and function-calling applications, achieves high accuracy. Off-policy RL fine-tuning can leverage interactions from larger models, including LLMs with alternative text prompts. However, even when models achieve reasonable syntax accuracy, they may only output specific subsets of the action space or make incorrect semantic decisions that fail to solve the task.

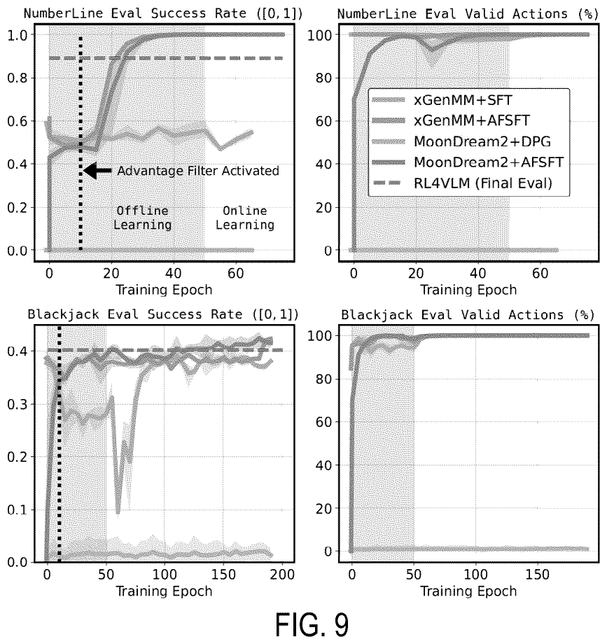

Performance can be improved by fine-tuning these same VLM-agents with LVLMQ (Eq. 7). FIG. 9 demonstrates this technique in two Gym Cards tasks. A dataset D is initialized with actions generated by a random policy, producing sub-optimal (random) decisions that are correctly formatted as text. Additionally, data collected from base VLM prompts-both inaccurate and low-performance—is incorporated. For demonstration purposes, the advantage threshold is initially set to β=−∞(Eq. 5), enabling the language head (RL actor) to optimize SFT on the sub-optimal dataset while also beginning to optimize the critic value regression loss (Eq. 6). This approach quickly brings both xGenMM and Moon-Dream2 to a similar performance level. After a few hundred gradient steps, the advantage threshold is scheduled to reach β=0, allowing the critic to filter out sub-optimal tokens within each turn's reply. As a result, the agent's performance improves to match or exceed the RL4VLM reference score. Since [symbol] _{VLMQ} is applicable in both online and offline settings, additional data collection from the RL agent remains an option. In this case, the agents have already reached high performance but maintain it as the buffer fills with fresh data. In RL, performance dips are common during the transition between offline and online learning due to distribution shift and related optimization challenges.

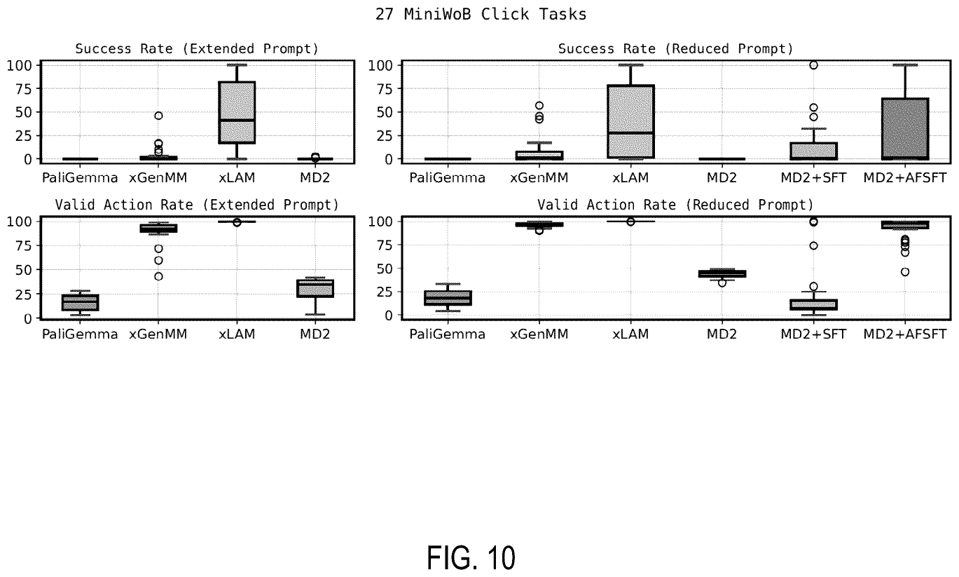

FIG. 10 also includes results from an alternative actor update that replaces Eq. 4 with a more standard online objective, which directly maximizes Q-values according to the current critic:

$${ℒ}_{DPG} ( i ) = - \frac{1}{l} {\sum }_{j = 0}^{l} {{L}_{ϕ} ( {h}_{i}^{j} )}^{T} \text{?} {Q}_{ψ} ( {h}_{i}^{j} ) \qquad ( 8 )$$

While effective in discrete actor-critic RL settings, this objective proves ineffective in this context due to miscalibrated Q-values in the critic network's output space, which result from large token vocabularies.

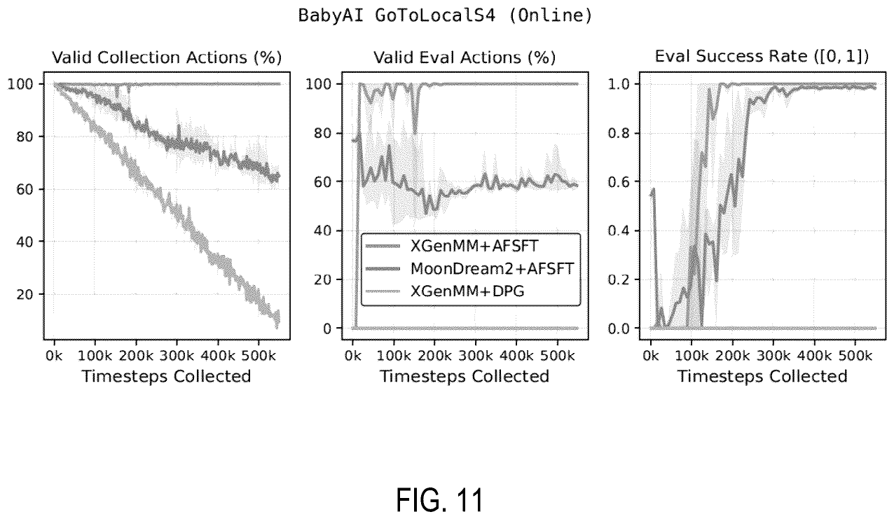

Training an RL policy from a fully offline dataset closely resembles the setup of SFT agent fine-tuning, where the ability to collect online data for performance improvement is an advantage. However, an alternative approach involves fine-tuning the VLM entirely online using a buffer of its own experience. FIG. 11 illustrates online learning in a BabyAI task. BabyAI provides a domain where the true action space consists of a small set of discrete choices, enabling a straightforward exploration strategy where the model's response is replaced with a random (valid) decision with probability E, which decays over time. Because the dataset includes some valid actions that bypass the syntax reward penalty, the AFSFT update learns to favor them over the model's own (inaccurate) outputs, resulting in a spike in action accuracy. The Q filter then selects actions that lead to task success over other valid but sub-optimal decisions, raising the VLM's success rate to nearly 100%.

For domains where the true action space consists of open-ended text or state-dependent code, generating valid exploration actions is more challenging. This is evaluated using the BrowserGym variant of the MiniWoB++benchmark. MiniWoB is a suite of locally hosted browser tasks for RL agents, while BrowserGym standardizes the interface for web tasks that require code-like action syntax. A dataset of 340k actions across 27 different “click” navigation tasks is collected using three VLMs and the xLAM LLM.

FIG. 11 summarizes these models' action accuracy and task success rates. A comparison is made between a detailed prompt, which includes HTML text along with a browser screenshot, and a simplified variant that reduces input length for efficiency. The dataset includes a portion of actions generated by filling the agent's action reply with the beginning of a randomly selected BrowserGym function call, introducing many inaccurate or irrelevant browser commands and creating a challenging offline RL problem. Fine-tuning is then applied to the worst-performing VLM (MoonDream2) using both SFT (Eq. 3) and AFSFT (Eq. 7). FIG. 11 highlights

$${ℒ}_{VLMQ}^{′} s$$

ability to sift through noisy datasets in order to recover a MoonDream2 policy that more closely resembles the best subset of our demonstrations.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of operating an automatic artificial intelligence (AI) agent over a computing environment via reinforcement learning (RL), the method comprising:
receiving, via a data interface, a user task request to perform a task over a computing environment;
iteratively generating, by a vision-language model of the AI agent, a next turn action based on an input of an observation of the computing environment and a current-turn action at a current turn, wherein the generating includes:
encoding, by one or more encoders of the vision-language model, the observation and the current-turn action into the observation representation and the action representation, respectively,
decoding, by one or more decoders of the vision-language model, one or more hidden states from the observation representation and the action representation,
generating, by one or more output headers, the next turn action and an estimated return following the current-turn action from the one or more hidden states;
computing a first loss based on a token distribution of the next-turn action and a filter that that masks action tokens according to the estimated return;
iteratively updating the vision-language model based at least in part on a gradient of the first loss at the current turn; and
iteratively executing the next-turn action over the computing environment thereby causing a transition into a next observation of the computing environment until the task is completed.

2. The method of claim 1, wherein the observation comprises an image of a screenshot of the computing environment at the current turn and a text description of a subtask request at the current turn decomposed from the task request.

3. The method of claim 2, wherein the one or more encoders comprise an image encoder to encode the image of the screenshot into an image representation, and a text encoder to encoder the text description into a text representation.

4. The method of claim 1, wherein the one or more output headers comprises an actor header that generates the token distribution of the next-turn action over a vocabulary of the vision-language model.

5. The method of claim 4, wherein the one or more output headers comprises a critic header that generates a number of tokens corresponding to a size of the vocabulary of the vision-language model, and wherein the filter is generated based on the number of tokens and the token distribution from the critic header.

6. The method of claim 5, further comprising:
computing a second loss based on the number of tokens output from the critic header, a ground-truth reward at a next turn, and approximated return for remaining turns.

7. The method of claim 6, further comprising:
iteratively updating the vision-language model based at least in part on a stochastic gradient of a weighted sum of the first loss and the second loss.

8. The method of claim 7, wherein the one or more decoders of the vision-language model comprises a low-rank adapted version of a decoder-only Transformer network.

9. The method of claim 1, further comprising:
decomposing the user task request into multiple turns of subtasks; and
generating, by the iteratively updated vision-language model, a sequence of actions at each turn of the multiple turns.

10. The method of claim 1, wherein the user task request corresponds to a training trajectory comprising multiple turns, and wherein each turn comprises the observation of the computing environment at the current turn, the current-turn action, a reward at the next turn, an indicator indicating whether the next turn reaches a final turn of task request execution, and an observation at the next turn.

11. A system of operating an automatic artificial intelligence (AI) agent over a computing environment via reinforcement learning (RL), the system comprising:
a data interface receiving a user task request to perform a task over a computing environment;
a memory storing a vision-language model and a plurality of processor-executable instructions; and
one or more processors to execute the plurality of processor-executable instructions to perform operations comprising:
iteratively generating, by the vision-language model of the AI agent, a next turn action based on an input of an observation of the computing environment and a current-turn action at a current turn, wherein the generating includes:
encoding, by one or more encoders of the vision-language model, the observation and the current-turn action into the observation representation and the action representation, respectively,
decoding, by one or more decoders of the vision-language model, one or more hidden states from the observation representation and the action representation,
generating, by one or more output headers, the next turn action and an estimated return following the current-turn action from the one or more hidden states;
computing a first loss based on a token distribution of the next-turn action and a filter that that masks action tokens according to the estimated return;
iteratively updating the vision-language model based at least in part on a gradient of the first loss at the current turn; and
iteratively executing the next-turn action over the computing environment thereby causing a transition into a next observation of the computing environment until the task is completed.

12. The system of claim 11, wherein the observation comprises an image of a screenshot of the computing environment at the current turn and a text description of a subtask request at the current turn decomposed from the task request.

13. The system of claim 12, wherein the one or more encoders comprise an image encoder to encode the image of the screenshot into an image representation, and a text encoder to encoder the text description into a text representation.

14. The system of claim 11, wherein the one or more output headers comprises an actor header that generates the token distribution of the next-turn action over a vocabulary of the vision-language model.

15. The system of claim 14, wherein the one or more output headers comprises a critic header that generates a number of tokens corresponding to a size of the vocabulary of the vision-language model, and wherein the filter is generated based on the number of tokens and the token distribution from the critic header.

16. The system of claim 15, wherein the operations further comprise:
computing a second loss based on the number of tokens output from the critic header, a ground-truth reward at a next turn, and approximated return for remaining turns.

17. The system of claim 16, wherein the operations further comprise:
iteratively updating the vision-language model based at least in part on a stochastic gradient of a weighted sum of the first loss and the second loss.

18. The system of claim 17, wherein the one or more decoders of the vision-language model comprises a low-rank adapted version of a decoder-only Transformer network.

19. The system of claim 11, wherein the operations further comprise:
decomposing the user task request into multiple turns of subtasks; and
generating, by the iteratively updated vision-language model, a sequence of actions at each turn of the multiple turns.

20. A non-transitory machine-readable medium comprising a plurality of instructions for an automatic artificial intelligence (AI) agent over a computing environment via reinforcement learning (RL), executable by one or more processors, wherein the plurality of instructions are configurable to cause the one or more processors to perform operations comprising:
receiving, via a data interface, a user task request to perform a task over a computing environment;
iteratively generating, by a vision-language model of the AI agent, a next turn action based on an input of an observation of the computing environment and a current-turn action at a current turn, wherein the generating includes:
encoding, by one or more encoders of the vision-language model, the observation and the current-turn action into the observation representation and the action representation, respectively,
decoding, by one or more decoders of the vision-language model, one or more hidden states from the observation representation and the action representation,
generating, by one or more output headers, the next turn action and an estimated return following the current-turn action from the one or more hidden states;
computing a first loss based on a token distribution of the next-turn action and a filter that that masks action tokens according to the estimated return;
iteratively updating the vision-language model based at least in part on a gradient of the first loss at the current turn; and
iteratively executing the next-turn action over the computing environment thereby causing a transition into a next observation of the computing environment until the task is completed.
